(19) United States
(12) Patent Application Publication
(10) Pub. No.: US 2020/0250730 A1
(43) Pub. Date: Aug. 6, 2020

(54) METHODS AND SYSTEMS THAT RETRIEVE AND SYNTHESIZE PRODUCT INFORMATION FROM MULTIPLE PURVEYORS AND PROVIDE COMPARATIVE PURCHASING OPTIONS

(71) Applicant: RAW SUPPLY, LLC, Midlothian, VA (US)

(72) Inventors: Alp Akbasli, Boynton Beach, FL (US); Willow Noonan, Piitsburgh, PA (US); Stephen Rogge, Midlothian, VA (US); Troy M. Thompson, Lexington, KY (US)

(21) Appl. No.: 16/782,053

(22) Filed: Feb. 4, 2020

Related U.S. Application Data
(60) Provisional application No. 62/800,638, filed on Feb. 4, 2019.

(51) Int. Cl. G06Q 30/06; G06Q 30/02

(52) U.S. Cl. CPC G06Q 30/0629; G06Q 30/0641; G06Q 30/0631; G06Q 30/0277

(57) ABSTRACT

A system retrieves and synthesizes product information from multiple purveyors and provides comparative purchasing options. An orchestration service can be implemented on a computing device based on a first request to establish a connection with individual accounts associated with a system account. A connection can be proxied with a server from the orchestration service to connections established with a plurality account specific product information sources (“ASP sources”). Accounts that are held with purveyors associated with the ASP sources and associated with the system account can be accessed, and the system can facilitate, with the server, a transmission of account specific product information (“ASP info”) from the accounts to the orchestration service. The orchestration service can synchronize purveyor-specific product information of the system account with the ASP info, and synthesize the synchronized purveyor-specific product information into inventory and price information for products corresponding to a product specified in a second request.

This application claims priority to U.S. Patent Application 62/800,638 filed Feb. 4, 2019 entitled “MULTI-PURVEYOR PRODUCT RETRIEVING, SYNTHESIZING, AND PURCHASING METHOD AND SYSTEM”, which is expressly incorporated herein in its entirety.

### BACKGROUND

This disclosure relates to certain industries that include commercial buyers who purchase products in bulk or as part of a service that is then provided to an end consumer. Such industries include but are not limited to the food/service industry (e.g., restaurants), automobile part supply industry (e.g., auto repairs shops, auto repair chains, etc.), and the cosmetic supply industry (e.g., individual salons, chains of salons, cosmetic retailers, etc.). These are examples of industries in which a commercial customer (restaurant, auto-shop, salon) may have accounts with each of several purveyors. The commercial customer may buy the same products or groups of products from these purveyors on a regular basis; products that may have to be bought frequently because they are part of a core product or service offering the commercial customer offers to its customers.

For example, in the food service industry, product price tends to be a dominant focus of commercial suppliers and customers alike, at every level of a supply chain. Until very recently, price analysis and comparison, something that is still not done with great effectiveness nor on a widespread basis, involved a restaurateur contacting a food service representative on any given day to spot-check pricing for a select number of products. This process is time consuming, inefficient, and unlikely to end with an overall cost savings.

Even if contacting food service representative and spot-checking prices was not time-consuming, other market factors would still make the process unlikely to result in savings. Typical of an industry norm for many geographic areas, the food representative in the above example would likely be employed by a major purveyor, who, along with one or two other major purveyors, tends to monopolize a market for food product supply in a geographic area including the restaurateur. Purveyors like the one employing the food service representative, are common and generally looked to for many types of products that an establishment that serves food and/or beverages may need. As a result, for a majority of restaurateurs in a given area, two or three major purveyors serve as the primary source of most of the food products those restaurateurs purchase. As one of ordinary skill in the art will readily understand, this means that there is little competition for those restaurateurs business since they have limited options for sourcing eggs, dairy, different types of produce, various meats, beverages, dry food products, or any other food/food-ingredient product that an establishment that serves food and/or beverages may need.

The spot-checking methods is still a common practice, but more and more in the food service industry are turning to online ordering options for their food product supplies. Online ordering, which in some cases can make up-to-the-second pricing available, has changed the way restaurateurs and other types of commercial customers place major operational orders to an appreciable degree.

Ordering from purveyors is an extremely large industry. In the food service industry, for example, small to medium restaurants can order over $500,000 worth of goods in a given year. Large restaurants, on the other hand, will make orders totaling in the millions over a year's time. Checking daily pricing online by visiting various purveyors' websites in any of the applicable industries has made price comparisons a more manageable process relative to the previously mentioned spot-checking method. However, online price checking it is still very time consuming. A commercial customer is likely to have different login credentials for each of the different purveyor websites. Further, each of the different purveyor websites may have a different way of organizing and providing access to information. An employee that a commercial customer, as an employer, would trust to point of being willing to give the employee login credentials to access a purveyor's website, is likely to be a valued member of the commercial customer's work force. The opportunity and labor costs for that kind of employee to compare the commercial customer's negotiated prices for groups of products across different purveyors, is more often than not, greater than the cost savings that may be realized when it is time to purchase the products. Thus, such an arrangement/distribution of labor can create a redundant inefficiency that makes it highly unlikely that the employer/commercial customer will realize a real and appreciable cost savings. This is even the case for restaurants, for example, where food costs can make or break a restaurant's bottom line.

As a result, a need exists for a platform that can be used by commercial buyers, for example restaurateurs, to compare purveyor-specific inventory and (often pre-negotiated) pricing information that has been aggregated from a plurality of information sources, such as purveyor-specific websites. In addition, a need exists for methods and systems that enable commercial buyers to quickly, efficiently, and cost effectively order supplies, intermediate products required for end products (e.g., foodstuffs or prepared foods), and end-product offerings through respective login-based accounts utilizing a single platform. Further, a need exists for a single platform that is configured to follow or carry-out purchasing protocols on each of a plurality of individual purveyor-maintained purchasing services/tools. These and other needs are addressed by the subject matter of the present disclosure.

### SUMMARY

Examples described herein include systems and methods for accessing multiple industry-specific product inventory and pricing accounts respectively assigned to single commercial customers or organizations of commercial customers. Each account that a customer has with a specific purveyor may normally be accessed individually, for example, through a network, such as the internet, pursuant to a respective user authentication protocol. In one example, a system according to the present disclosure can aggregate negotiated pricing and inventory information from a customer's respective accounts with different purveyors and provide a comparison and purchasing platform. In one example, the platform can follow, carry out, or comply with all required protocols implemented by a purveyor's login-based website or login-based purchasing service that an individual customer might have navigate to view inventory statistics and purchase products from the purveyor.

In one example, a system according to the present disclosure can provide a secure third-party service that is configured to aggregate information from online ordering systems/interfaces implemented by multiple purveyors, in a highly transparent manner that effectively passes the cost benefits of having a single ordering platform down to commercial buyers. The systems and methods described herein can be advantageously utilized by individuals or business entities focused on one of several large industries, or sectors of those industries. For example, in the restaurant sector of the food service industry, the systems and methods described herein can provide a restaurateur with a central interface the restaurateur can interact with to: (1) receive prices for products from multiple purveyors in real time; (2) shop for better pricing or compare product quality for virtually the same products/items; and (3) save money. In one example, the present disclosure describes an interface that provides a commercial buyer with a single login configured to: (1) cause authentication processes with one or more servers to be carried out; and (2) grant the commercial buyer with access to (their account specific) pricing information from multiple purveyor sites.

In another example, a commercial customer, such as a restaurateur, may use a client device that implements a browser configured to retrieve a website from a web service. The retrieved website can contain server generated client-side code, for example JavaScript, that embodies or otherwise provides an orchestration service that is configured to open socket interfaces, connect directly to purveyor websites, and retrieve product information. In one example, the purveyor websites may be HTML-based websites, that the orchestration service connects to via a network, such as the internet. The orchestration service can parse data from the purveyor websites and populate local storage on the client device with pricing and other information.

Alternatively, or in addition to the local storage, an orchestration service can store and retrieve information from the web service in an encrypted form. For example, purveyor credentials can be stored in an encrypted form by a management server, and can only be decrypted by a user (for example, by using the user's password or a derivative thereof as the decryption key). Also, for example, the system may not be responsible for storing unencrypted password information, but instead may store hashing information or other information sufficient to authenticate user password information in the absence of storing it. Upon logging in using the password for a user's system account, the management server can provide the encrypted purveyor information directly to the user, who can decrypt it directly using their password. The decrypted information (for example, login credentials) can be directly used to make requests to an account-specific product information and purchasing source maintained or otherwise employed by a purveyor (e.g., a supplier or distributor) using provisioning software, for example, via a website, or another type of a software-based component.

Additionally, and alternatively, the management server or other system managing component of the system, can proxy requests made by a user for the purpose of orchestrating retrieval of purveyor information, including product information, feedback, and pricing data. Initially, the purveyor information can be encrypted directly by the user using the user's system account password and stored locally or by the system in encrypted only data, potentially allowing only the user to understand a meaning and content of the encrypted data. For example, in the event of a compromise, purveyor information can only be accessible to the user in possession of the system account password, which is not stored anywhere other than by the user directly and personally, or potentially institutionally. In another example, the orchestration service can load website data retrieved from purveyor websites into a JavaScript object. Loading of the website date into a JavaScript object, can, according to one aspect of the present disclosure, facilitate the reading, interpretation, manipulation, and/or potential storage of the website data through implementations of the web service. In another example, the orchestration service can aggregate and display the information retrieved from the purveyors' websites in the browser.

In one example, an orchestration service can open socket interfaces to purveyor systems to enable the placing of orders. The orchestration service can: (1) facilitate logging into purveyor websites; (2) format and transmit order data as necessary to place an order; (3) parse purveyor website-generated successful or unsuccessful order placement information; and (4) display the order placement information in the browser.

In another example, a management server can provide a proxy service through which orchestration service can connect to purveyors. The management server can be operated to facilitate multiple concurrent connections with different purveyors using only a single persistent connection between the management server and the orchestration service. In one example, the orchestration service can connect to the management server that can proxy a persistent websocket connection from the orchestration service to any other type of connection (e.g., TCP sockets) required to connect to the purveyor websites. In various examples, the management server can be implemented in hardware, software, a combination of hardware and software, or as a cloud-based web API.

In still other examples, orchestration service can open socket connections to a management server to send product information or statistics to the management server, and/or retrieve additional information from the management server. In one example, the additional information may be information not available directly from purveyors, and can include, in one example, product ratings, reviews, feedback, and/or aggregate product statistics. The orchestration service can also open socket connections to other clients and exchange information in a peer-to-peer manner. In this example, a need for data to be retrieved from purveyor websites and sent to and through the management server, may be reduced or obviated in total. The orchestration service can obtain information about other clients to connect to from various sources including, but not limited to, the management server, a publicly accessible website or location, or a stored list of other clients.

In yet another example, a web client implements a processing mechanism and is configured to parse information from purveyor websites accessed via a network, such as the internet, and store or otherwise place the parsed information in a database. The database can be utilized to receive and store information as mentioned, and may be configured to send order information to purveyor websites via the network. In addition, the database can be utilized in conjunction with a computer front end that includes a web server and a user interface. In one example, the user interface enables a user to interact with the web server via a network, and send or receive information to or from the database. In receiving the information, the user may receive information from purveyor web page(s) through the database and the network. In sending the information, the user may send order information, such as an order placed for products, to one of the purveyors' websites, and cause the order to be submitted to that purveyor's web server.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart that illustrates an exemplary method for retrieving and synthesizing product inventory and pricing information from multiple purveyors, and providing a user with multiple purchasing.

FIG. 2 illustrates an exemplary system of components for retrieving and synthesizing product inventory and pricing information from multiple purveyors, and providing multiple purchasing options for which a user can be significantly informed.

FIG. 3A is a sequence diagram of an example method for obtaining account-specific product information (“ASP info”) from a plurality of account-specific product sources (“ASP sources”) maintained or utilized by respective purveyors.

FIG. 3B is a sequence diagram of an example method for utilizing ASP info to synchronize and display purveyor specific information (“PS info”).

FIG. 4 is a sequence diagram of an example method for synthesizing PS info according to a product or products specified in a product information request.

FIG. 5 illustrates an exemplary system of components for retrieving and synthesizing product inventory and pricing information from multiple purveyors, and providing multiple purchasing options for which a user can be significantly informed.

FIG. 6 illustrates an exemplary system of components for retrieving and synthesizing product inventory and pricing information from multiple purveyors, and providing multiple purchasing options for which a user can be significantly informed.

FIG. 7 illustrates an exemplary system of components for retrieving and synthesizing product inventory and pricing information from multiple purveyors, and providing multiple purchasing options for which a user can be significantly informed.

FIG. 8 illustrates an exemplary system of components for retrieving and synthesizing product inventory and pricing information from multiple purveyors, and providing multiple purchasing options for which a user can be significantly informed.

FIG. 9 illustrates an exemplary system of components for retrieving and synthesizing product inventory and pricing information from multiple purveyors, and providing multiple purchasing options for which a user can be significantly informed.

FIG. 10 is an illustration of an example graphical user interface (“GUI”) of a console used to perform the various methods described herein.

FIG. 11 is an illustration of an example graphical user interface (“GUI”) of a console used to perform the various methods described herein.

FIG. 12 is an illustration of an example graphical user interface (“GUI”) of a console used to perform the various methods described herein.

FIG. 13 is an illustration of an example graphical user interface (“GUI”) of a console used to perform the various methods described herein.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Aspects of the systems and methods described herein can help a commercial buyer realize several cost reducing and operations optimizing benefits by providing the commercial buyer with certain abilities which include, but are not limited to, an ability to: price compare between purveyors using existing or new accounts; easily research price statistics, geographical averages, minimum and maximum prices paid for products in relation to time periods (e.g., seasons) and geographical area; compare/review similar products/items for quality control; order based on reviews from other commercial buyers; find new purveyors through advertising, reviewing ratings, or using geographical positioning; place orders directly from a single platform (no need to log into multiple accounts); order products through a fast and simple process that can be further aided by an ability to save previous orders, make custom lists, etc.; provide information on how much a commercial buyer has saved in a current order, historically over time, or how much could be saved going forward in regards to their costs; and view price histories of given products.

Other beneficial aspects of the present disclosure can include providing purveyors with abilities that include, but are not limited to, an ability to: gain exposure with commercial buyer accounts specific to their service regions organically, or via targeted advertising; connect to commercial buyer client software via an API which makes purveyors instantly available to commercial buyers for the purposes of account creation; to advertise directly to commercial buyers while they place food orders; significantly reduce overhead and cost of sales force by not requiring as many sales representatives in the field to sell to industry specific clients, like restaurants or cosmetic dealers, on a daily basis.

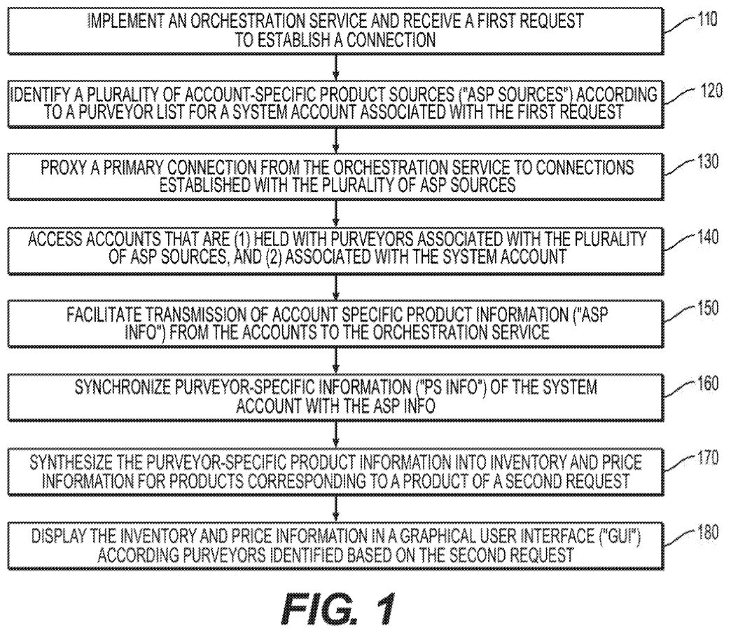

FIG. 1 is a flowchart that illustrates an exemplary method for retrieving and synthesizing product inventory and pricing information from multiple purveyors, and providing a user with multiple comparative purchasing options.

In general, the method of FIG. 1 illustrates how a system according to the present disclosure establishes and maintains system accounts that commercial buyers can respectively access. A system account, as discussed with reference to stages 110 to 140, may include purveyor-information, buyer account-information, and purveyor specific product-information with respect to different purveyors that have been previously specified by a commercial buyer, and with whom the commercial buyer has independent buyer accounts with. Access may be granted through an authentication process administered by the system, wherein the commercial buyer can enter their respective credentials, and the system can verify the credentials correspond to a system account that the system maintains.

At stage 110 a system according to the present disclosure can implement an orchestration service and receive a first request. In one example, the system can include a management server and the orchestration service. The management server can instantiate, or otherwise generate, the orchestration service and cause the orchestration service to be deployed in an interface being implemented on a computing device. Deployment can occur with the management service establishing the orchestration service in the interface over a network through which the computing device and server are connected.

In one example, the first request is a request by a user that is logged into the system and submits the request through a graphical user interface (“GUI” or “buyer UI”) to obtain new information on products the user purchases from one or more purveyors. The user, in one example, can be a person or entity considered to be a commercial customer of, and holds accounts with, each of the one or more purveyors. In yet another example, a process of a user logging into the system may cause the orchestration service to generate and transmit the first request the management server of the system automatically.

In stage 120, the management server can identify a plurality of account-specific product sources (“ASP sources”) according to a list of purveyors for a system account associated with the first request. In one example, an ASP source includes a purveyor specific platform a purveyor uses to communicate with, inform, and offer products to a customer or other entity that may hold an account with the purveyor. In one example, each of one or more of the ASP sources could be provided with a website that a purveyor maintains. In another example, each of one or more of the ASP sources may be provided as an intranet site that is maintained by an enterprise computing infrastructure, the enterprise or a specific division thereof filling the role of a purveyor, and enterprise employee and/or other enterprise divisions holding accounts with the enterprise or specific division. In still another example, each of one or more of the ASP sources could be provided as a stand-alone application maintained by a purveyor and implemented on computing device such as a phone or a tablet, for example.

In one example, identifying the ASP sources includes the management server (1) registering an address or a process for connecting with each of the plurality of ASP sources, and (2) creating a queue for reaching out to or otherwise connecting with the ASP sources, and (3) causing connections to be established. In one example, one or more connections established between the management server and the plurality of ASP sources are socket connections (web, transmission control protocol (“TCP”), internet protocol (“IP”), user datagram protocol (“UDP”), raw, or other type of socket connection).

In one example, the address or process for connecting to each ASP source may be stored in the system account associated with the first request. In another example, the management server may maintain addresses and processes separate from system accounts. Further, the management server can use the list of purveyors included in the associated system to lookup the addresses or processes for connecting to the ASP sources maintained by the purveyors identified from the purveyor list.

At stage 130, the management server can proxy a primary connection from the orchestration service, being implemented through the interface on the computing device, to connections established by the management server with the plurality of ASP sources. In one example the primary connection is a socket connection.

In one example, the management server establishes the connections by processing the first request in stage 120 as previously described, prior to establishing the primary connection. In another example, the connections and the primary connection are established at the same time or attempted to be established simultaneously. In still another example, the management server may delay establishing the connections with the plurality of the ASP sources, until the primary connection is established with the orchestration service. In this example, the management server performs the identification of the ASP sources and respective addresses or processes, and determining a queue order for establishing connections in stage 120. The queue order is then referenced and carried out in stage 130 once the primary connection is established

In stage 140, the accounts held with the purveyors of the plurality of ASP sources are accessed by the orchestration service through the proxied connection established by the management server in stage 130. More specifically, the management server pulls sets of credentials stored in the system account for the user submitting the first request in stage 140. Each set of credentials corresponding to one of the plurality of ASP sources identified in stage 120. In one example, the management server carries out a login process or otherwise executes a protocol mandated each of the plurality of ASP sources to gain access to the account held with a respective purveyor by the user associated with the first request.

At stage 150, the management server can facilitate transmission of account-specific product information (“ASP info”) from each of the plurality of ASP sources. In one example, the orchestration service transmits a call for product information (“ASP info call”) for each ASP source through the primary connection.

Each of the ASP info calls may be passed through the management server and directed to the appropriate ASP source through a respective connection established between that ASP source and the management server. In this example, the orchestration service may receive a notification that the primary and other connections have been established from the management server. In addition, the management server may provide the orchestration service with an address, data retrieve protocol, and identity of a purveyor for each of the ASP sources. Accordingly, the orchestration service can include or otherwise incorporate this server provided information in the ASP info calls to ensure each call is routed to the correct ASP source. In yet another example, the management server can generate and transmit the ASP info calls in stage 150.

In response to the ASP info calls, each of the plurality of ASP sources can transmit the requested or otherwise most current ASP info through the connections with the management server. The ASP info provided may include a document object model (“DOM”) or a plurality of DOMs corresponding to webpages of one or more ASP sources that are produced in at the ASP source in response to receiving the ASP info call. In one example, the ASP info can pass directly to the orchestration service. In another example, the management server can route the ASP info, in its raw form, to a database. As raw ASP info is stored in the database for any one of the plurality of ASP sources, a version of the same ASP info having just been stored can be routed to the orchestration service in stage 150.

In stage 160, legacy purveyor-specific information (“PS info”) stored in association with the system account for the first request, can be synchronized with the ASP info. Synchronization stage 160 can include comparing price, availability date, quantities, age, source country, order minimums, and any other characteristic of products provided in PS info and the ASP info. Further, the PS info can be updated with any changes recognized by the orchestration service in processing the ASP info. In another example, synchronization can replace the PS-info with the ASP info.

At stage 170, a second request can be received by the GUI and processed by the orchestration service. In one example, the second request can specify one or more products, or product types, for which the user desires current pricing and inventory information. In response to the second request, the orchestration service can identify or otherwise process the product(s) or product type(s) from the second request, and use this information to synthesize the PS info. In one example, synthesizing includes parsing the PS info to find product offerings from any of the purveyors which the user holds an account with, which relate to the product(s) and/or product type(s) specified in the second requested.

In one example, as the PS info is parsed, the orchestration service identifies related product offerings and pulls price, inventory, and purveyor information for each related product offering. In one example, the orchestration service can group the identified product offerings by any category noted above with can group relevant product information according to purveyor. In addition, the orchestration service pulls price and inventory information from the parsed PS info

At stage 180, the orchestration service can instruct, operate, or otherwise cause the GUI to display the product offerings identified through the synthesis of the PS info. In one example, the inventory and price information can be presented or otherwise ordered according to price, purveyor, availability date, order minimum requirements, or a combination thereof. Thus, the user will be able to compare the product offerings from different purveyors the user holds accounts with. In particular, the user will be able to compare the product offerings based on one or more factors or metrics of availability that may be important to the user for that user's particular business needs at a particular time in the near, not to distant, or distant future. Further, the systems and methods described herein are directed toward providing users with an ability to purchase products from the purveyors using their accounts with those purveyors, through the same interface the user is utilizing to compare the different product offerings from different purveyors the user holds accounts with.

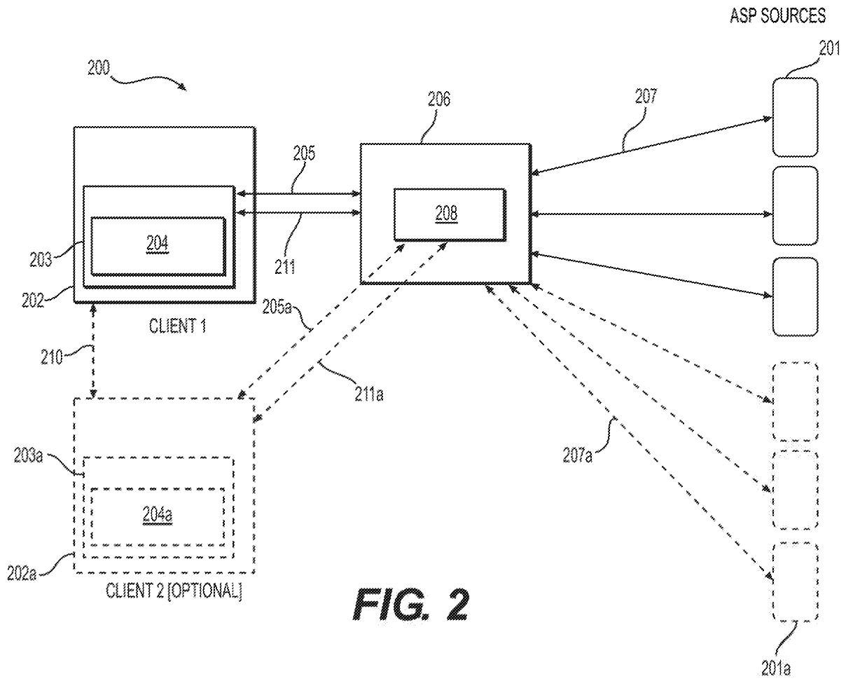

FIG. 2 illustrates an exemplary system 200 of components for retrieving and synthesizing product inventory and pricing information (“product information” or “product information data”) from multiple purveyors, and providing multiple purchasing options for which a user can be significantly informed.

In one example, the system 200 incorporates a plurality of purveyor websites 201, 201a (“purveyor websites 201”), one or more client devices 202, 202a (“client devices 202”), and a management server 206, which are connected over a network, for example the internet. In one example, the network is comprised of various network connections 205, 205a, 207, 207a (“network connections 205, 207,” or “network connection 205 of the network,” or “network connection 205,” or “network connection 207 of the network,” or “network connection 207”). In another example, the client device 202 is any computing such as a computer, tablet, phone, smartphone, or other device that includes a processor and a memory where information can be stored. The management server 206 can include one or more servers connected over the network connections 205, 207 to the client devices 202 and the purveyor websites 201 (e.g., via respective web servers for the websites 201). The management server 206 can include one or more data storage servers, and one or more authentication servers, and implement a resource coordination service 208.

In one example, client-side server-generated code 204, 204a embodies or otherwise provides an orchestration service (“client-side code 204” or “orchestration service 204”) that can be implemented on a client browser 203, 203a (e.g., a web browser such as CHROME, FIREFOX, INTERNET EXPLORER, ELECTION, etc.). In another example, the orchestration service 204 can include a set of instructions that cause connections between the client device 202 and the purveyor websites 201 to be made through, or otherwise facilitated by, the management server 206. In various examples according to the present disclosure, the management server 206 can: include a node.js server and/or a serverless web API, or the like; store front end and account-related information; and store product information data (parsed or unparsed) obtained from purveyor websites.

The management server 206 can act as a proxy through which the orchestration service 204 can connect to the purveyor websites 201. The management server 206 can allow multiple concurrent connections with the purveyor websites 201 (or more generally, web servers supporting the websites 201 respectively) using only a single persistent connection between the management server 206 and the orchestration service 204. For example, the orchestration service 204 can connect to the management server 206, and cause the management server 206 to proxy a persistent websocket connection from the orchestration service 204 to any other type of connection (e.g., TCP sockets) required to connect to the purveyor websites 201. In various examples, the management server 206 can be implemented in hardware, software, a combination thereof, or as a cloud-based web API.

The client devices 202 can include a first client device 202 and a second client device 202a. The management server 206 can push down instructions to the client devices 202 through another network connection 210 that causes the client devices 202 to connect to one another and share data, for example through a peer to peer (“p2p”) data sharing protocol. This sharing protocol can be implemented through p2p channels, such as, for example, sockets (web or other types of sockets) configured for p2p data sharing.

The orchestration service 204 can also open socket connections 211, 211a (“socket connections 211”) to the management server 206 for sending product information or statistics to the management server 206 or another data repository. In addition, the socket connections 211 can be utilized to retrieve additional information from the management server 206, such as information that is not available directly from the purveyor websites 201. In one example, such additional information may include product ratings, reviews, feedback, or aggregated product statistics. The orchestration service 204 can also open socket connections 210 as previously discussed, with other clients and exchange this additional type of information in a p2p manner. In one example, by implementing p2p communication, a need for product information data to be retrieved from the purveyor websites 201 and sent to/through the management server 206 may be reduced or obviated on a one-time, semi-frequent, or frequent basis. The orchestration service 204 can obtain information about other clients to connect to from various sources, for example, from the management server 206, publicly accessible websites or locations, or a stored list of other clients.

A further aspect of the present invention includes displaying a digital advertisement within a user front end for consumption in a visual form by commercial buyers. The advertisement could be from one of a plurality of purveyors, and could display one or more promotions. The advertisement location could vary depending on various pricing models as negotiated between the advertiser and an administrator of the system 200.

According to another aspect of the present disclosure, a user of the systems described herein may be able to use more than one user interface. Thus, a commercial buyer (user) could have an option to add or contact additional purveyors that the commercial buyer does not currently have an account with, and potentially compare pricing with these additional purveyors. In another example, a second user interface could be provided and display price comparison information. In turn, a commercial buyer may be motivated to add new additional purveyor accounts, or simply educate themselves with information that could be used for any other reason. In yet another aspect of the present disclosure, an additional interface may be configured such that an advertiser could have an option to purchase an advertisement that will be seen by a commercial buyer located within a certain geographic area when that commercial buyer is logged into the second user interface.

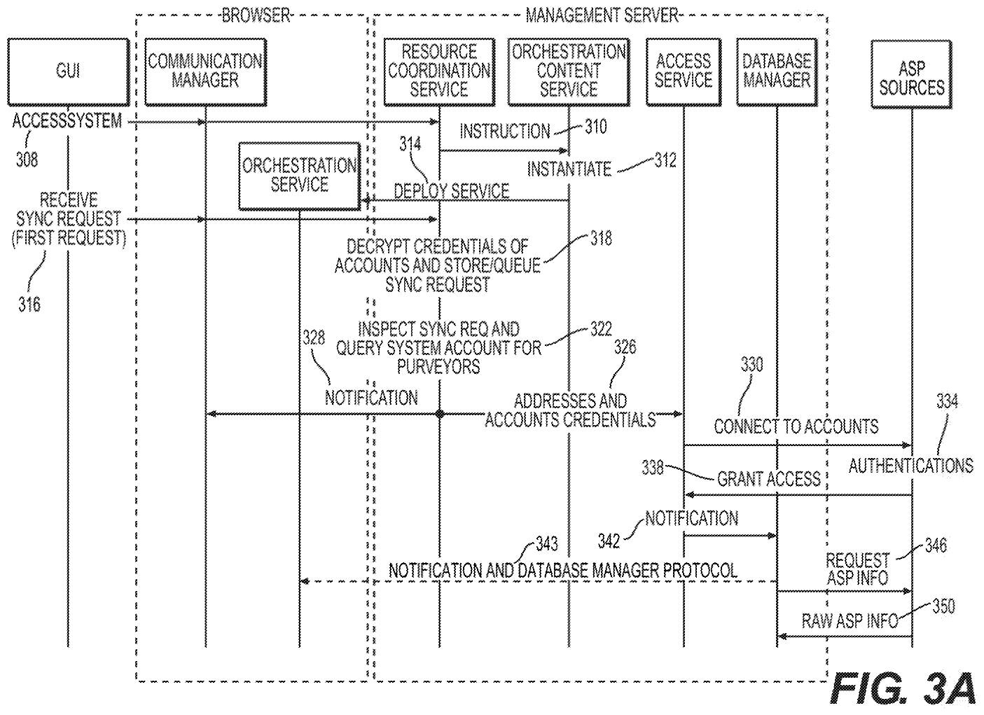

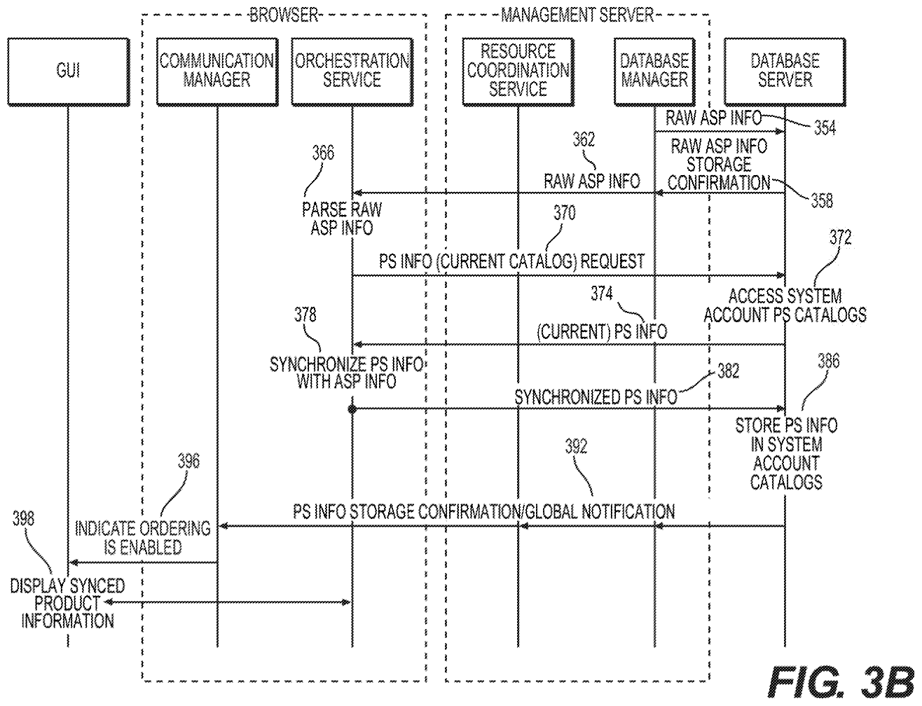

FIG. 3A is a sequence diagram of an example method for obtaining account-specific product information (“ASP info) from a plurality of account-specific product sources (“ASP sources”) maintained or utilized by respective purveyors.

At stage 308, a GUI that may be presented on a computing device, such as a phone, table, laptop, desktop, or the like, can (1) receive an instruction to access an interface for a system managed by a management server, and (2) forward that instruction to a communication manager being implemented in a browser. In one example, stage 308 can include a user using the browser to access a website, intranet site, web application, or dedicated application that is supported by a system managed by the management server. One of ordinary skill in the art would readily recognize that either the computing device or the browser (by itself) could be considered a client of, for example, a server, such as the management server.

The management server can provide a backend of a system that enables the exemplary stages illustrated in FIG. 3A to be performed (stages 310, 312, and 318 to 346 in particular). In one example, the management server can be embodied or otherwise provided as several servers in communication with each other. The server or group of servers can provide an entirety or a portion of a backend supporting the system

The communication manager can, as part of stage 308, forward the instruction to a resource coordination service of the management server. In one example, the resource coordination service can include a web-based application program interface (“API”). In another example, the resource coordination service can include a web API that employs a simple object access protocol (“SOAP”). In yet another example, the resource management service can include a web API that employs or otherwise implements representational state transfer (“REST”) based services.

In another example, stage 308 can include a commercial customer (user) that holds a system account, logging into the system managed by the management server. In yet another, stage 308 can include the user creating a system account. As a result, the resource coordination service can perform an authentication process with credentials provided by the user in stage 308. The resource coordination service lookup the supplied credentials in a list, internal storage, or database, or pass the credentials on to a third-party verification service that performs the lookup process, to determine if the supplied credentials are a match to the credentials of a system account. Where a match is determined, the resource coordination service can authorize access to information in a respective system account for future requests.

In stage 310, the resource coordination service can process the instruction and determine whether appropriate security protocols have been established and/or a connection with the computing device on which the browser is being implemented. This may occur even if stage 308 results in a successful login to a system account. Where the resource coordination service determines that the connection meets or follow any and all predetermined requirements and/or protocols, then an instruction to deploy an orchestration service may be transmitted to an orchestration content service.

At stage 312, the orchestration service can be instantiated by an orchestration content service and at stage 314, the orchestration service can be deployed in the browser.

The orchestration service can include code that is configured to operate within or otherwise be implemented by the browser on the computing device. The code included by the orchestration service can, in one example, be based on or include objects from a library, or framework, such as ANGULAR, EMBER, VUE, BACKBONE, REACT, or the like. In one example, the orchestration content service can instantiate the orchestration service in stage 312 through a process of accessing a storage of the management server, another server or external source, or other repository associated with a library or framework on which the code included by the orchestration service is based.

Once the library or framework is accessed, the orchestration content service may obtain certain objects or code; check that a stored library is up to date; or get a new library based on an operating system or other characteristic of the computing device or browser being implemented on the computing device. In one example, the code included by the orchestration service may incorporate: a scripting language, such as Javascript, or another type of programming language can implemented on a client; or a language, such as Typescript, Dart, Kotlin, Babel, Wyvern, Flow, or the like, which can be complied by scripting language or other type of programming language.

With regards to deployment of the orchestration service, on some examples stages 312 and 314 may be combined. More specifically, the orchestration content service can communicate with the browser directly, or through the communication manager, to instantiate and deploy the orchestration service in the browser as the browser is being implemented on the computing device. In this example, the orchestration content service can include a web application that serves content to the browser/computing device. In another example, the orchestration content service can instantiate or otherwise generate the orchestration service, which is then deployed in the browser by the resource coordination service.

In stage 316, a first request can be received through with the GUI and forwarded to the resource coordination service by the communication manager.

In one example, the first request is received and transmitted by the communication manager where a user logged into the system managed by the management server in stage 308, or sometime prior to entering the first request in the GUI. In one example, the first request can include a request to synchronize purveyor-specific information and/or obtain product information from a new ASP source. In this example, the first request can include a request to synchronize purveyor-specific information for the system account associated with a logged in user, with current ASP info available from the ASP sources for the purveyors that the user holds accounts with.

In other examples, the user may have several options for making the first request. Each option can be presented in the GUI as button or other visual queue, and a request to synchronize a certain sub-set of the ASP sources for purveyors that a user holds accounts with. In particular, the user may use a “favorites” sync option which cause synchronization to be carried out with ASP source for a specific list of purveyors that a user, such as a restaurant or food establishment, references to order from frequently. Another option presented to the user in the GUI could be a “full sync” option in which synchronization occurs with respect to an entire product catalog for each of the ASP sources linked to the user's system account. In another example, “product specific” option could be provided to the user, which includes list of one or more of the purveyors, and a list of products that the user, as a commercial customer, purchases on a frequent basis. Each type of synchronization may take place upon selection of a respective option that is presented in the GUI. In one example, once a synchronization of any type has begun, a status bar may be presented (through the browser or dedicated application) in the GUI indicating a progress of the synchronization in a percentage format.

In another example, the first request can be sent as request to synchronize purveyor-specific information or call for a synchronization, that is automatically included or coupled with credentials that are submitted with a login attempt by a user. In this example, the communication manager can generate the call once credentials are received, and the resource coordination service may only processes or otherwise read the call if the credentials are authenticated and authorization is granted. In one example, the user can set an account setting to a preference that includes an automatic synchronization of one, a certain few, or all of the ASP sources associated with a system account upon a login into that system account. In another example, this setting can be set to a preference for the system to wait from an isolated synchronization request after login occurs.

At stage 318, the resource coordination service can decrypt credentials held in the system account for the logged-in user, for one or more of the accounts (depending on the synchronization option selected) which the user holds with the purveyors for the ASP sources. In one example, each ASP source may be associated with or otherwise maintained by a respective one of the purveyors that a user (commercial buyer/customer) holds an account with, which as has been registered in the user's system account. In another example, one or more ASP sources may be platform used by one or more of the purveyor's the user holds an account for order placement, but not necessarily the purveyor's website.

In addition to decrypting the credentials, the resource coordination service stores the first request for a synchronization in a queue. In one example, the queue may be a queue of synchronization requests for the user and other users having a system account and who have submitted a synchronization request for their respective ASP sources. In another example, the queue may be specific to the ASP sources associated with the system account corresponding to the first request. More specifically, the queue may be defined as queue of the ASP sources that the resource coordination service will, or attempt to, establish connections and access accounts with. Thus, the queue may be an order (address) calls or sets of connection protocols, each call or set of connection protocols corresponding to a respective ASP source.

In one example, the queue may be established according to a purveyor prioritization order that is stored in the system account for a user. In one example the prioritization order can be established by the system, for example by the resource coordination service, based on an amount, a frequency, and/or recency that a user has placed orders with certain ASP sources. In yet another example, the prioritization order may be set by a user and stored in the user's system account.

In stage 322, the resource coordination service can inspect the first (synchronization) request and query the system account for any account credential information that has not already been pulled and is required to access the user's accounts through the ASP sources.

In stage 326, the resource coordination service and transmit a notification to the communication manager indicating a synchronization process has begun. In one example, the communication manager can forward or package the notification in a certain way to be presented to a user via the GUI.

At stage 328, the resource coordination service transmits account credential information and addresses for the ASP sources to an access service. In one example the resource coordination service sends a packet or distinct group of packets according to the queue. Accordingly, each packet or distinct group of packets includes account credentials and address for an ASP source. The credentials or the address information can include the call or connection protocols stored in the queue for a given ASP source in stage 318. The address component (e.g., website, intranet site, dedicated application access point) can be any piece of information that access service can use to establish an initial line of communication with a respective ASP source.

In stage 330, the access service can use the addresses provided to establish communication with the ASP sources, and then supply account credentials and make a call or follow a set of connection protocols, to respectively access accounts for the user with the ASP sources. Access of an account can include establishing a connection, such as a socket connection, between the management server and a respective ASP source.

At stage 334, each of the ASP sources can perform a respective authentication process and grant access to respective accounts in stage 342.

At stage 342, in response to receiving access to any of the accounts, the access service will transmit a notification to a database manager of the management server. In one example, the database manager is an agent implemented by the resource coordination service of the management server. In one example the database manager serves as a data gathering and directing component of the system. More specifically the database manager may manage or otherwise direct a flow of info to a database of the management server or a database server that is part of the system. In the case of the latter, the database server communicates with the management server via the database manager.

In another example, the access server can additionally or alternatively transmit the notifications transmitted, or that would be transmitted, in stage 342, to the orchestration service in optional stage 343. In addition to the notification, the access service may include: (1) protocol, address, or instruction for having requested information routed to the database manager; and (2) an instruction to the orchestration service to include the protocol, address, or instruction with a request to the ASP sources of the accounts referred to in the notification.

At stage 346, the database manager, having access to the connection with one or more ASP sources, submits a request for account-specific product information (“ASP info”). In particular, the database manager submits a request through the connection established with each of the ASP sources for which the database manager receives a notification for from the access service. In one example, the notification specifies a connection address or access protocol implemented by the management server use that connection to request and receive information.

In another example in which optional stage 343 is performed, the orchestration service can send a request for ASP info through the access service and the appropriate connection established thereby, to one or more of the ASP sources.

In one example, the request generated by the database manager is a request for the raw document object models (“DOMs”) for webpages of a purveyor's website which provides an ASP source. More specifically, the database manager, or in some examples, the orchestration service, may implement a process through the request in stage 346 in which webpages which are specific to the account accessed, are continuously call and DOMs retrieved therefrom, until a point at which all webpage relevant to the request have been called and DOM retrieved.

In stage 350, the database manager can receive raw ASP info from the ASP sources.

In one example, communication between in stages 330, 346, and 350 is accomplished by establishing sockets. For example, a series of requests to authenticate can be transmitted via sockets. In addition, other sequences of requests to obtain raw ASP info can follow the series of authentication requests. In one example, the requests for raw ASP info can include requests to pull down raw DOMs of product pages of an ASP source.

In other examples, where an ASP source corresponds to a purveyor that is a government, international, or other regulatory agency, or an industry dominant entity, such as U.S. Foods (“USF”), other means of communication may be implemented as needed. For example, the access service may communicate with this type of purveyor through a node library or other high-level API providing service, solution, or software component, such as Puppeteer, can be implemented to control another software component, like Chromium, that can provide source code that can be compiled into a web browser. In this example, the complied source code can provide a means for authentication with an ASP source, and then the database manager or orchestration service can navigate to the product pages and save raw ASP info. As noted above, the raw ASP info can be provided in the form of raw DOMs.

FIG. 3B is a sequence diagram of an example method for utilizing ASP info to synchronize and display purveyor specific information (“PS info”).

At stage 354, the database manager can route the raw ASP info to a database server. In one example, the database server may be part of the management server or one of the servers in a group of servers that make up the management server. In another example, the database server is a separate server that may be maintained or part of another computing infrastructure or provided by a third-party. In still another example, the database server may be a cloud-based server or a virtual sever.

In stage 358, database server can store the raw ASP info on stage 358, as well as transmit a notification to the database manager confirming storage has been completed. In one example, the raw ASP info is transmitted to the database server from the database manager as it is received from ASP sources on a continuous basis. In other examples, the database manager can compile all of the ASP info from all of the ASP sources before transmission to the database server.

As the raw ASP info is stored, it can be made available to the orchestration service. If a user is logged into their system account, the orchestration service can receive the raw ASP info (e.g., a raw DOM) in a synchronization request response. The orchestration service is not required to wait for synchronization request to be fulfilled from all ASP sources associated with a system account of the first request to start receiving and parsing ASP info.

At stage 362, the database manager forwards raw ASP info to the orchestration service in response to the storage confirmation notification from the database server. As discussed above, the database manager can transmit raw ASP info to the database server at it is received. Likewise, the database server can send storage confirmation notifications to the database manager as raw ASP info is stored. In turn, the database manager can transmit raw ASP info corresponding to one or more ASP sources that are associated with a storage confirmation notification from the database server, as the notifications are received. Thus, the system may not require a user/browser/user device to wait for a synchronization request to complete pulling all of the raw ASP info for all of the ASP sources before transmission to the orchestration service in stage 362 occurs. As raw ASP info is obtained, for example, as a page is scraped, and the raw ASP info is stored by the database server for any single increment, for example by product page, that raw ASP info can be made available to the orchestration service for parsing in stage 366 discussed below.

In stage 366, the orchestration service can parse the raw ASP info. In one example, parse can include using a library of terms or previously processed product information to recognize purveyors, products, and other product information.

In one example previously noted, the raw ASP info is provided in the form of raw DOMs that may have been scraped or otherwise obtained from product pages of purveyor websites providing one or more ASP sources. In this example, parsing the raw ASP info (raw DOMs) can include the orchestration service parsing the raw DOMs into respective arrays of product objects. In one example, the orchestration service can utilize a programming language, such as JavaScript, to pars the raw ASP info in the browser. All parsing can occur on a “client side” in the browser. The ASP info will be parsed into purveyor-specific product information (“PS info”) and transmitted to the database server in stage 370

In stage 370, the orchestration service with requests catalogs of product information previously stored in the database server and corresponding to purveyors that match any of the purveyors the parse ASP info. In response, the database server can recognize the purveyors in from the parse ASP info that have catalogs stored with the database server at stage 372.

In stage 374, the database server can pull from the purveyor catalogs the most current PS info corresponding to the PS info request transmitted in stage 370. In one example, the request can specify only certain number of products or portion of a catalog required from a synchronization, and the PS info return in stage 374 may only include cataloged product information for those products.

At stage 378, the orchestration service can synchronize the PS info with the parse ASP info and transmit the synchronized PS info to the database server in stage 382. In turn the database server can store new and update or replace existing PS info in purveyor catalogs for a system account corresponding to the first request of stage 316.

In one example, the system can perform or provide and option for multi-level synchronizing of product information. For example, the first request can be an identified synchronization request (e.g., for user's favorite purveyors), a selective search in which alternative purveyors/alternative sources are requested, or a full synchronization for all available products from all ASP sources of all purveyors associated with a system account of the first request.

In one example, any of stages 372, 378, or 386 can include a process for detecting inconsistencies in ASP info, PS info, or synchronized PS info. Detected inconsistencies can cause a re-initiation of a synchronization or re-check of product information. In other examples, the re-initiation or re-check may be user initiated or re-initiated. In other examples, detection can occur an initial check or loading of raw ASP info, current PS info, or storage of synchronized PS info. Any of these processes may be triggered or otherwise flagged by alternative an data source, such as another user or user's system account that anonymously compares product information and which is prevented from accessing an identity of another user.

In yet another example, the system according to the present disclosure may perform dynamic syncing of ASP info with PS info. In particular, where any inconsistency between the data stored on the user's supply cannon software changes relative to information relating to, or retrieved from a purveyor catalog, the system, via the orchestration service or the resource coordination service, can cause a prompt to be presented in the GUI to a synchronization procedure initiated.

In stage 392, the database server can transmit a notification confirming that the synchronized PS info has been stored to the database manager. The notification can in turn be transmitted to the resource coordination service and the communication service. In stage 396, the communication can generate, or cause the GUI to generate or otherwise present an indication that product information has been synchronized and/or pulled for the first time (e.g., for new users, or for new purveyors for existing users).

In stage 398, the GUI can display the synchronized product information.

In one example, stage 398 can include selective loading of additional information. In some examples, not all available product details will need, or requested, to be loaded initially, or even as part of a standard synchronization, or any level even including a full synchronization request. In some examples, product details can be retrieved when requested, or on a product-by-product (or set-wise selective) basis for a particular product or set of products. These products may appear in, or are otherwise be relevant to products being presently displayed or listed in a display, or otherwise viewable by a user. In another, example product details can be retrieved (or re-checked) for products/items returned by a search entered by a user.

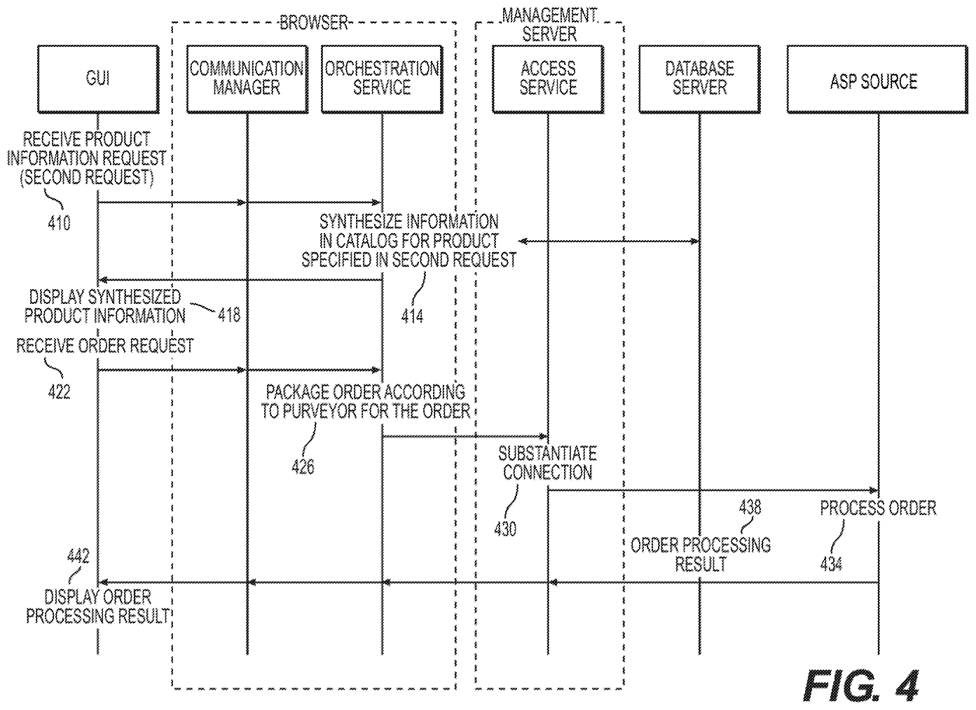

FIG. 4 is a sequence diagram of an example method for synthesizing PS info according to a product or products specified in a product information request.

In stage 410, a second request for information regarding one more products, can be received by and the GUI and transmitted to the orchestration service. In turn, the orchestration service can synthesize product information, as described above, form catalogs in the database server relevant to the product(s) of the second request.

In one example, the orchestration service or the database server can implement alternative product/item search and determination service that calculates a standard deviation of pricing information based on fuzzy matching product/item title or description. In another example, a threshold percentage or variance can be used in place of standard deviation. In yet another example, machine learning can be used to model pricing information for purpose of determining alternatives based on manually inputted data including custom alternatives selected by user or other training data. Additionally, machine learning data can include alternative product/item filtering that may be designated or otherwise specified by one of the entities mentioned previously.

In stage 418, the synthesized product information can be displayed in the GUI. In one example, this can include and automatic-optimize pricing process wherein a least expensive products for which a minimum order requirement is met, may be listed in order of least to most expensive. In one example, a user may be presented with an option to “auto optimize” or some variation that when selected, can assist the user in achieving the most optimum order optimizing combinations of pricing, order minimums, ratings and potentially other criteria, to save both time and money and create a great user experience. This auto-optimize functionality may require the user to pre-fill a quantity of each product/item he, she, or it (entity) wishes to order then the optimization can take place.

In another example, when alternative products/items are displayed, alternatives from purveyors whose order minimum has not yet been met may be displayed in a separate portion of a display in the GUI.

At stage 422, an order request can be received through the GUI from a user. This request may be forwarded to the communication manager which in turn communicates the order request information to the orchestration service. In one example, the orchestration service may deploy in stage 418, and auto-generated order page that presents an order experience that is native to a user. The orchestration service may determine based on previous orders, what a user typically orders from the purveyors they hold accounts with, and use this as basis to auto generate an order page.

In stage 426, the orchestration service can package the order according to a purveyor, or corresponding ASP source, for the order, and forward the order to the access service of the management server.

At stage 430, the access service can establish a connection, such as a socket connection, with an ASP source corresponding to the order. The order can be processed by the ASP source in stage 434, after which a result of the order can be transmitted to the access service in state 438. The result of the order, whether successful or unsuccessful, may be displayed in the GUI in stage 442.

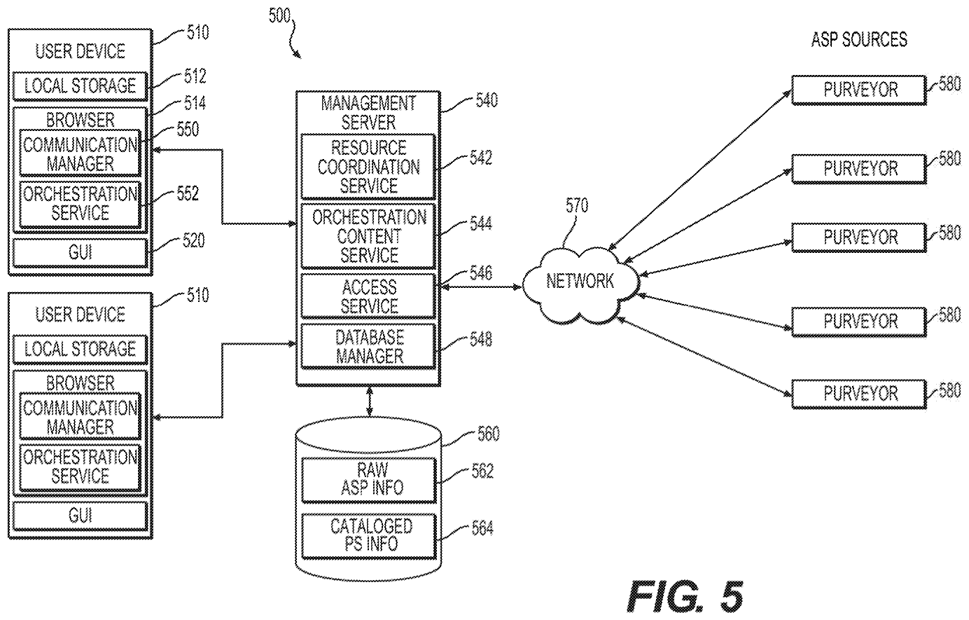

FIG. 5 illustrates an exemplary system of components for retrieving and synthesizing product inventory and pricing information from multiple purveyors, and providing multiple purchasing options for which a user can be significantly informed. In one example, the system components include a management server 540, a database server 560, and communication managers 550 and orchestration services 552 which are generated and/or maintained by the management server 540 and the database server 560.

The management server 540 can include one or more servers in one example. In another example, the management server can be a virtual server that is hosted in a web application, such as Azure, or a on a dedicated virtual machine (“VM”). As previously discussed, the management server can implement or host a resource coordination service 542, an orchestration content service 544, an access service 546, and a database manager 548.

In one example, the resource coordination service 542 may include a web API that provides REST based services, manages authentication, and interacts with a backend. The orchestration content service 544 may include a web application delivers content to a client as defined by a browser, user device, and/or user. In one example, the orchestration service can serve an angular application to the browser and cause deployment of the orchestration service on the user device 510. The access service 546, in one example, can send requests to ASP sources 580 via a network 570 (e.g., by establishing socket connections), and then forward responses back to an orchestration service 552 of the system 500. The database manager 548 can provision or manage the provision of data to be stored in a database that is, in the case of the system 500, provided by a dedicated database server 560. The database server 560 can store raw ASP info 562 and cataloged PS info 564 as illustrated.

The user devices 510 with which the management server 540 communicates/connects with, can be any processor-enabled computing device, such as a laptop, tablet, cell phone, personal computer, or the like, that includes one or more processors and memory storage locations. In one example, each of the user devices 510 can include a local storage 512, implement a browser 514, and display or otherwise present a GUI 520. Operation of a communication manager 550 within the browser 514 can be managed or otherwise directed by the resource coordination service 550. The orchestration service 552 can be instantiated in the browser 514 the orchestration content service or the resource coordination service as previously discussed.

In one example, the orchestration service 552 is configured to run in the browser 514, and implement logic to parse ASP info and compose orders to be submitted to ASP sources. In another example, the orchestration service 552 or the communication manager 550 can handle, or otherwise direct requests for authentication, database interaction, ASP info, and placing orders to the management server 540.

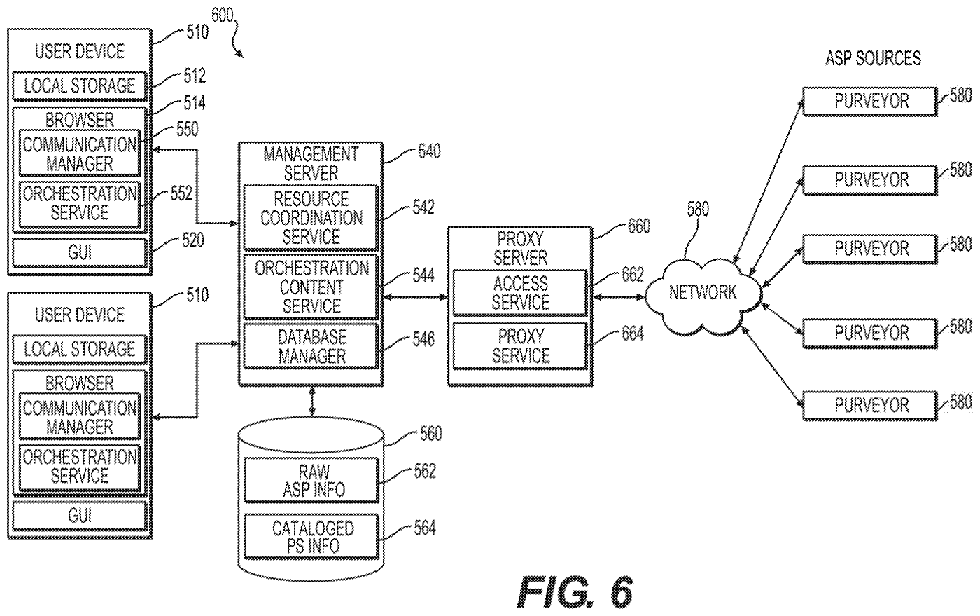

FIG. 6 illustrates an exemplary system 600 of components for retrieving and synthesizing product inventory and pricing information from multiple purveyors, and providing multiple purchasing options for which a user can be significantly informed. As illustrated, the system 600 of FIG. 6 includes a management server 640, the database server 560, and a proxy server 660. In one example, the management server 640 includes or implements all the components as the management server 540 of the system 500 of FIG. 5, except an access service. Rather, the proxy server 660 implements an access service 662 and a proxy service 664.

The proxy server 660 may be a “light weight” server that runs a node library, such as node JS. The access service 662, like the access service, the access service 546 in the system 500 of FIG. 5, can send requests to ASP sources 580 via a network 570 (e.g., by establishing socket connections). However, the requests may be received from the resource coordination service 542. In addition, the access service 662, in one example, may forward responses back to the database manager 546 of the management server 640. On the other hand, the proxy service may be configured to compile a programming language, such as Javascript, and parse files or objects, such as j son objects, that are composed of a host, port, and command elements.

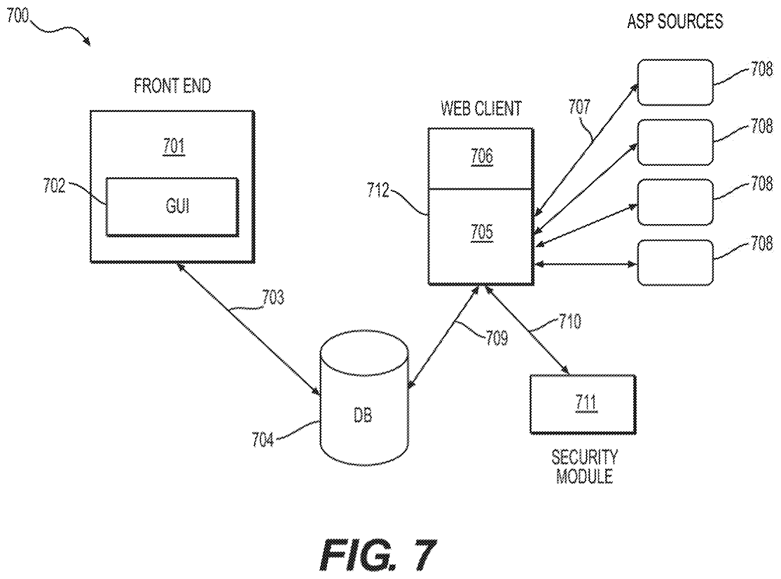

FIG. 7 illustrates an exemplary system 700 of components for retrieving and synthesizing product inventory and pricing information from multiple purveyors, and providing multiple purchasing options for which a user can be significantly informed. In one example, the system 700 provides an aggregation system for comparing pricing from commercial suppliers' (e.g., restaurant purveyors) websites 708. The system 700 comprises a front end comprising a web server 701 which displays a user interface 702 (“UI 702”). The UI 702 provides a tool for the commercial buyer to interact with the system 700, and generally comprises of a graphical interface accessible via a web browser, connected to the server via a network. The network most often comprises, but is not limited to, the internet.

The UI 702 may comprise one of many web design software tools, or may be coded using HTML, Javascript, Python, or the like, and configured to create a graphical user interface (GUI), such that the system 700 appears user-friendly to the commercial buyer. When information is sent to/from the front end to a database 704, it can be done so through a network 703, such as the internet. Furthermore, when information is sent to/from the database 704 to a web client 712 comprising a processing mechanism 705, it can be done so through a network connection 709 for a network comprised of multiple network connections 703, 707, 709, 710, 711. It is noted that the responsibility of the database 704 is to store parsed product information that is collected and sorted by the processing mechanism 705. The information, prior to being parsed, having been retrieved from purveyor's websites 708 via another network connection 707. In addition, the database 704 store the information along with storing/retrieving historical product information and/or product order information.

Product information may comprise, but is not limited to, one or more of the following fields of informational data elements: product name, product description, product price, product image, and product SKU number. Obtaining and ordering of product information can be done, without being limited to, through implementations of one or more of the following methods: using an application programming interface (API) provided by a purveyor or alternate sources by implementing an orchestration service that manages series of requests to and responses from the API; or writing a specifically coded set of instructions using a dynamic programming language (“DPL”) so as to embody or otherwise provide an orchestration service that instructs the web client 712 to fetch data including product information from each of the purveyors' websites 708 via the network connection 707. The DPL may include, but is not limited to, one or more of GO (Google's programming language), Python, and C++. A software tool used for managing the database 704 may include, but is not limited to, one of: MongoDB, MySql, DynamoDB, or an open source database software tool. The processing mechanism 705 has multiple responsibilities. As previously mentioned, in on example, the processing mechanism is configured to obtain the product information data from purveyors' websites via the network connection 707, parse the data, and transmit the parsed data via the network connection 709 for storage within the database 704.

In another example, the processing mechanism 705 may be configured to place an order from a commercial buyer with the appropriate purveyor's web site 708 (via an appropriate web page of the website) using the network connection 707. This task can also be performed using one or more of the programming languages mentioned above. The web client 712 of according to the present disclosure may further include a daemon 706 configured to automatically fetch desired product information from the purveyors' websites 708 (i.e. pricing, product name, etc) during a scheduled time interval, via the network connection 707 of the network. In one example, the web client 712 can include a hardware security module 711 (“HSM 711”) connected to the processing mechanism 705. The HSM 711 can be provided for storing all of the commercial buyer's login information/credentials required to access each purveyor's websites 708, such that the commercial buyer may log into the front end using a single login and the web client 712 will automatically log into all purveyors' web servers supporting their respective websites 708 through the web client 712.

In the event a commercial buyer, such as a restaurateur, sends information, such as a request to place an order, such a request will be signaled by the front end to the database 704. The request to place the order could then be routed from the database 704 to the processing mechanism 705 and from there routed by the processing mechanism 705 to a corresponding purveyor website 708, via the network connection 707. Where a commercial buyer is receiving information from one of the several purveyor websites 708, for example, if a commercial buyer desires to check the price of tomatoes from one of a plurality of purveyors' websites, a request to fetch the information is sent from the front end, thereby signaling to the processing mechanism 705 via network 703 and 709, such that the desired information is fetched from the processing mechanism 705 via network 707. The desired information is then passed through the database 704 via network 709 and passed along to be visibly present to commercial buyer via network 703 and via UI 702 on front end web server 701.

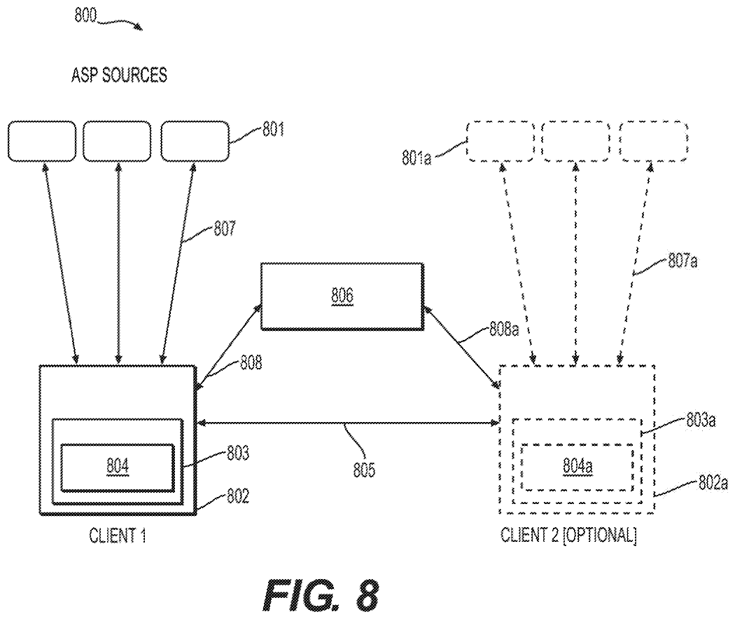

FIG. 8 illustrates an exemplary system 800 of components for retrieving and synthesizing product inventory and pricing information from multiple purveyors, and providing multiple purchasing options for which a user can be significantly informed. In one example the system of components incorporates a plurality of purveyor websites 801/1001a (“purveyor websites 801”), one or more client devices 802/1002a (“client device 802” or “client devices 802”), and a management server 806, which are connected over a network, for example the internet, comprised of various network connections 805, 805a, 807, 807a, 808, 808a (“network connections 805, 807, 808” or “network connection 805 of the network,” or “network connection 805,” or “network connection 807 of the network,” or “network connection 807,”). In one example, the client device 802 is any computing such as a computer, tablet, phone, smartphone, or other device that includes a processor and a memory where information can be stored. The management server 806 can include one or more servers connected over the network 807. In one example the management server 806 includes one or more data storage servers and one or more authentication servers.

In one example, client-side server-generated code 804, 804a embodies or otherwise provides an orchestration service (“client-side code 804” or “orchestration service 804”) that can be implemented on a client browser 803/1003a (e.g., a web browser such as CHROME, FIREFOX, INTERNET EXPLORER, ELECTION, etc.; hereafter referred to as “client browser 803”). In one example, the orchestration service 804 can include a set of instructions that cause connections between the client device 802 and the purveyor websites 801 through, or facilitated by the management server 806. The management server 806 can: include, for example a node.js server, a serverless web API, or the like; store front end and account-related information; and store product information data.

In one example, connections may be socket connections, may be maintained w/purveyor websites, and allow for sending and receiving data therethrough. In another example, the orchestration service 804 can parse data from the management server 806 and the purveyor's websites 801, and cause the parsed information to be stored on the client device 802. In yet another example, coupled with website retrieval, information can be exchanged with the management server 806 by way of an asynchronous data exchange over a network connection 808 that can include a socket connection.

The client devices 802 can include a first client device 802 and a second client device 802a. The management server 806 can push down instructions to the client devices 802 through the network connection 808. The instructions can cause the client devices 802 to connect to one another and share data, for example through a p2p data sharing protocol. This sharing protocol can be implemented through p2p channels, such as, for example, sockets 805 (web or other types of sockets) configured for p2p data sharing.

In the system 800 of FIG. 8, a commercial customer may use the client device 802, wherein the client device 802 can comprise a browser 803. The browser can be a standard web browser or an alternative configuration, such as ELECTRON, that may be less restrictive. The browser 803 can retrieve a website from a web service. In one example, the web service can be employed by the client device 802 independent of the management server 806. In another example, the web service may be connected to the client device through the management server 806 or other system 800 compatible components (hereafter referred to as “the web service”). The retrieved website can contain client-side server generated code, for example JavaScript, that embodies or otherwise provides the orchestration service 804. The orchestration service 804 can cause connections, such as socket interfaces, to be made that connect directly to the purveyor websites 801 and retrieve product information, for example, as HTML-based websites, via a network connection 807 of the network which may be the internet.

The orchestration service 804 can parse the data from the purveyor websites 801 and populate local storage on the client device 802 with pricing and other information. Alternatively, or in addition to the local storage, the orchestration service 804 can store and retrieve information from the web service, for example, in an encrypted form. The orchestration service 804 can load the website data retrieved from the purveyor's websites 801 into a JavaScript object so that it can be read, interpreted, and manipulated, and potentially stored using the web service. The orchestration service 804 can also aggregate and display the information retrieved from the purveyor websites 801 through the web service and/or the management server 806 in the browser 803.

The orchestration service 804 can also open socket interfaces to the purveyor websites 801 for the purpose of placing orders. The orchestration service 804 can handle logging into the purveyor websites 801, formatting and transmitting order data as necessary to place afn order, and parsing the results to display in the browser 803 that the order was successful or unsuccessful.

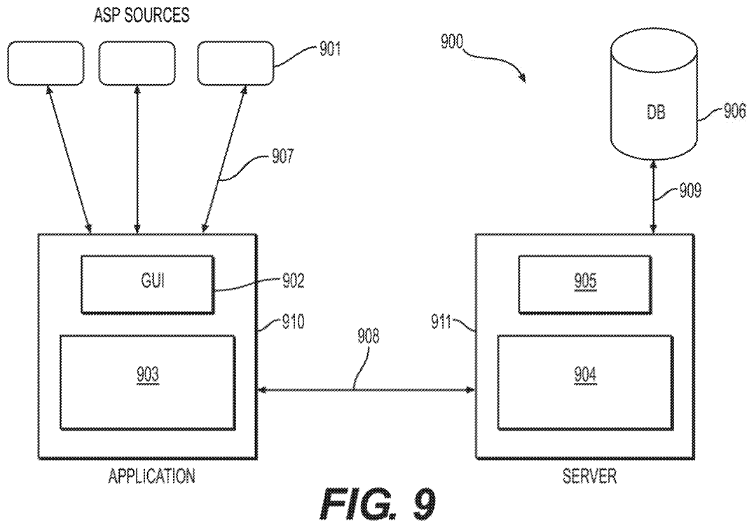

FIG. 9 illustrates an exemplary system 900 of components for retrieving and synthesizing product inventory and pricing information from multiple purveyors, and providing multiple purchasing options for which a user can be significantly informed. The system 900 cand include a server 911 that is connected to a database 906 via network connection. The server 911 may implement a resource coordination service 904 and database manager 905. The server 911 can communicate with a user device via a network connection 908. The user device 910 can include a browser 903 and a GUI 902, can communicate with a plurality of ASP sources 901.

Certain aspects of a user experience are discussed with respect the methods of FIGS. 1, 3A, 3B, and 4. Those and other aspects of a user/commercial buyer experience are further described as follows. A user experience for a commercial buyer using a system described herein can begin by the commercial buyer visiting, via a network (generally the internet), a web page of a website maintained by the system. Once the commercial buyer visits the web page, he or she may interact with an interface (hereafter “buyer UI”) provided by the system through a graphical user interface (“GUI”). More specifically, the buyer UI can serve as a tool through which the system provides the commercial buyer with a general ability to view and use system retrieved and synthesized product information, as well as exercise one or more comparative purchasing options provided by the system through the buyer UI.

In one example, the system, through the buyer UI, can allow a commercial buyer to sign up/register for an account with a set of credentials specific to a platform embodied by the system. Sign up/registration can additionally include the commercial buyer selecting an option to agree to a set of terms of the use. The option to agree can be presented in the buyer UI in the form of a check box. The terms of use can stipulate, and the system can enforce, a limitation that only one system account can be held by a single commercial buyer. Sufficiently strong usernames, passwords may be required for security. In one example, the commercial buyer can create an account and confirm the account by email verification.

In another example, the commercial buyer may log into a confirmed system account and can view an account summary page (“summary page”) with various account-specific information (e.g., personal information, billing and payment information, potential purveyors they may be considering to connect with through the system, etc.). To move past the summary page to a price comparison page, the system may require synchronization of at least one of the one or more purveyor accounts that has been linked to the commercial buyer's system account. Purveyors that are linked with the system account currently being displayed in the summary page, may be selectable from list of those purveyors also displayed in the summary page. Once at least one supplier is added, the commercial buyer may be able to press a button to “Place an Order” and move forward to a next part of a purchasing process managed by the system according to the present disclosure.

Once a “Place an Order” selection is made, the commercial buyer can be taken to another page to select a delivery date using a calendar. In one example, the commercial buyer can be required to select a delivery date. In other examples, where a delivery date is not specified, a default date may be automatically selected based on a minimum lead time that is preset by the system or the purveyor, and/or an earliest available delivery date. Once a delivery date is selected, either by the commercial buyer or through the default rule, the system can load a marketplace portion of the platform embodied by the system.

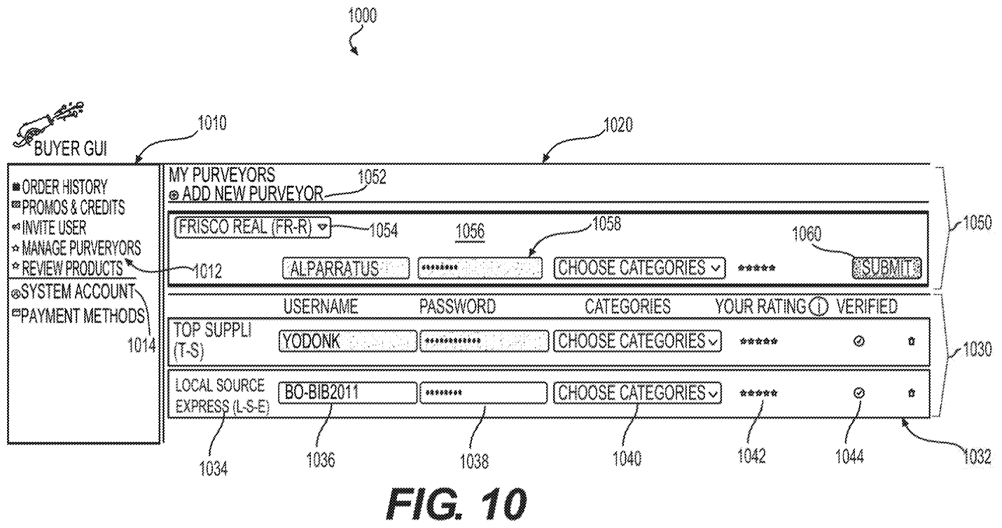

The marketplace, as presented in the buyer UI, can be characterized as an online marketplace, with categories (e.g., “Meat,” “Produce,” “Dairy,” “Eggs,” “Specialty Products/items,” “Dry Food Products/items,” etc.) in one section, such as a left side. Another section, such as middle section, of the marketplace as presented by the buyer UI could be focused on special or featured products/items. However, it will be understood that a layout can vary or be optimized in any way. Examples of the GUI are illustrated in FIGS. 10-13, which are described in detail below. The marketplace may comprise a display of product information data parsed from information from a purveyor's website. The purveyor website provided information having been obtained through the synchronization that was performed with the selection of the purveyor, by the commercial buyer, from the summary page. In one example, only products/items that would available for delivery on delivery date previously chosen, may be displayed.

A commercial buyer could select a category, such as “Meat,” displayed in one section of a page of the GUI that includes the marketplace. As result of the selection, another section of the page could display various products/items with images and titles (e.g., “Ground Beef,” “Steak,” “Chicken Breast,” etc.) that may constitute sub-categories of the previously selected category. In addition, this section of the page could operate as shopping website. For example, if a commercial buyer selects an item, for example “Ground Beef,” the system can take the commercial buyer to a specific product/item page that displays the title of the item, an image thereof, and prices from purveyors offering that product/item and linked to the commercial buyer's system account. In one example, product/item offering from only those purveyors for which a synchronization has been performed during a current login session may be displayed. In another example, product/item offerings for the selected product/item from of all the purveyors linked to the system account may be displayed, regardless of a synchronization status. In another example, only product/item offerings from those purveyors for which a synchronization has been performed within a predetermined period of time may be displayed.

The layout of a marketplace page of the GUI can be such that each purveyor's product/item offering can be displayed with a corresponding specific unit price (e.g., $6.99 per pound), and there can also be a rating for: (1) a purveyor's product represented by the product/item offering; and/or (2) the purveyor overall. The rating can be according to an associated rating system (e.g., 1 to 5 stars, a score between 1 and 10, a percentage of reviews that qualify as being positive, etc.). There can also be a shopping cart icon near the product/item offering, and if the commercial buyer selects an product/item offering and a quantity, a product associated with the product/item offering may be added to the commercial buyer's shopping cart in the quantity selected.

In addition, on an product/item offering page, the commercial buyer may click on a rating for any one of the plurality of purveyors listed. For example, a first purveyor may offer ground beef for $6.99/lb, and have 2-star rating, while a second purveyor listed on the product/item offering page may offer ground beef for $7.99/lb, and have a 4-star rating. The commercial buyer could, in one example, be given an option to click on the rating for either purveyor, and a written reviews page or pop-up for that product from that purveyor could be generated or otherwise display. The reviews could be written by other commercial buyers, and help inform the commercial buyer about the quality of the product in question. The commercial buyer could also have the option to “add a review.” After a commercial buyer selects an product/item and adds it to a cart, the commercial buyer could be redirected back to the marketplace page, where they can continue shopping.

Once a commercial buyer is finished shopping, they may finish an order by clicking on a shopping cart icon and be taken to a separate shopping cart page. Within the shopping cart page, the commercial buyer could be able to see if they are meeting any minimum purchase requirements required by a purveyor or if there are any problems with the products (i.e. out of stock, price change). Once the commercial buyer is satisfied with the products in their cart, they could select a “complete order” option to have an order processed by the one or more purveyor websites through operations of the system.

In one example, the system and methods described herein can allow users to utilize a subscription model in which the user is billed when the user logons on to the system and the user uses the system. This can include a payment model in which users pay for increments of time based on usage of the system, as tracked through their respective system accounts. For example, using the increment of one (1) month. If a user were to log in and had a payment on file, the user would be charged for a monthly billing cycle starting at that time of login. The user would be able to access the services within that monthly billing cycle, but as soon as that billing cycle ended, there would not be another forced payment. The next payment would only be charged the next time the user logs in after the previous billing cycle has expired. If customer information is a requirement for payment, the website can prompt the customer for the appropriate input at the time of login following the expiration of existing credit or payment mechanism availability. If appropriate, payment can be made automatically at the time of login transparently.

This can be useful for cryptocurrency payments, such as bitcoin. Also, if a user has a coupon, this can be applied at the time when payment is requested. Also, as an example, a user paying in cryptocurrency could potentially be charged less due to less processing fees than credit card.

FIG. 10 is an illustration of an example graphical user interface 1000 (“GUI 1000”) of a console used to perform the various methods described herein. As shown, the GUI 1000 includes a navigation window 1010 and a purveyor add window 1020. The navigation window 1010 includes selectable options for showing previous orders placed with the system. I one example, each order may have multiple purveyors within the order. The navigation window 1020 can also include a current promotions option for view promotions that a user has currently active (e.g., a free month of service that might show the beginning and end day of a referral bonus). Current promotions such as friend referrals that could potentially give user a free month of system account usage may be viewable from here. In addition, the navigation window 1010 may include a system account option 1014 that a user can select to view account settings, such as name, telephone, email, and the like. A credit card can be added on file, that credit card could be stored with a third party, user could also pay using cryptocurrency or potentially other accepted payment means.

The purveyor window 1020 may including a purveyor list section 1030 and a purveyor add/remove section 1050. In the purveyor list section 1030, each purveyor entry 1032 can display a purveyor name 1034, a username filed 1036 and a password field 1038 that may include this information which the user uses to access their account with an ASP source for the purveyor name in the purveyor field 1034. Thus, login usernames for specific purveyor accounts, previously entered and saved for future, use can be displayed in full here. In the case of passwords, some data can be indicated in a hidden form as shown. Optionally, a user may select specific categories for a purveyor using a category select option 1040.

Products/items can be reviewed with a star rating 1042 to help other users identify which products/items are preferred vs others. A rating designation indicating a user's level of satisfaction or dissatisfaction for a purveyor can thus be entered. This information could be used to determine a reputation score that can be view by other users ordering products through their respective system accounts.

In addition, the purveyor list section may include indicators 1044 that let a use know if a purveyor has been verified once submit button 1060 has been selected for a supplier add operation described below. If credentials entered for an add operation are determined to be invalid, an ‘X’ indicating that the credentials are not valid may be displayed for that purveyor in the purveyor list section 1030.

The purveyor add option 1052 can be selected by a user to bring up a credential entry window 1056 as shown. The entry window 1056 can include a purveyor selector option 1054 in the form of a dropdown box or other type of selection option. Purveyors that may be selected with the selector option 1054 may be limited to those purveyors with ASP sources that are system compatible or for which compatibility has not yet been determined but can be sought by the system. Account login fields including username, password, and category fields 1058 may be filled in (required to be filled in) by a user before the submit option 1060 can be selected and a verification process executed.

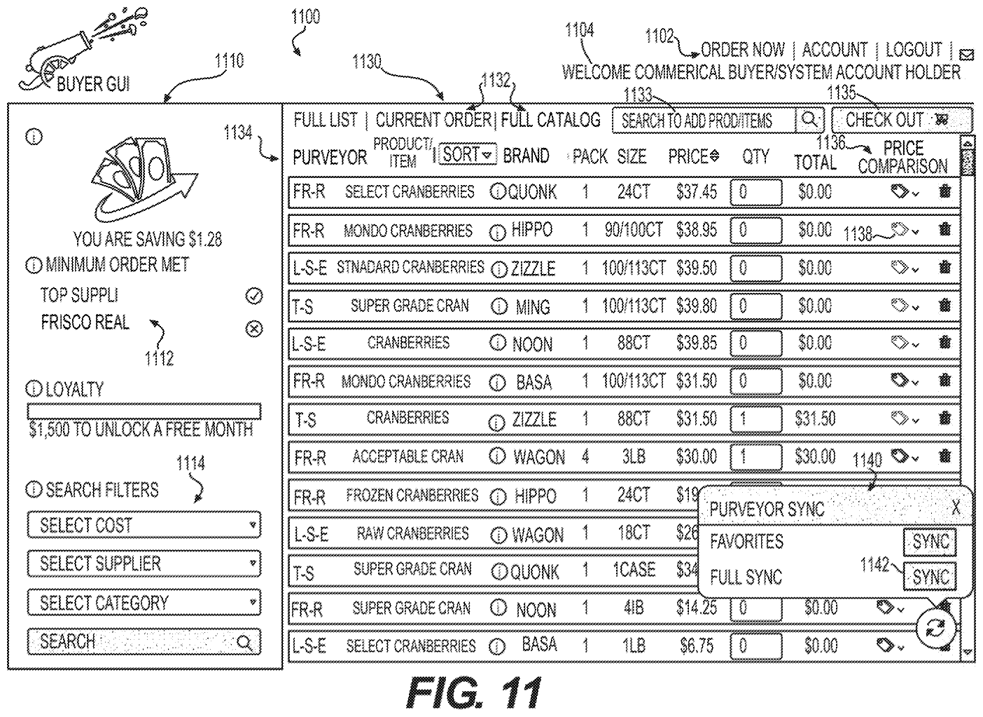

FIG. 11 is an illustration of an example graphical user interface of a main order console 1100 used to perform the various methods described herein. As shown, the main order console 1100 can include a navigation bar 1102, and a user identifying field 1104 that displays a user for a system account being displayed. As shown, the navigation bar 1102 can include an order now selectable option that can take a user to a current page, an account option that takes the user to an account page with all account functionalities, and a log out option. Further, the main order console can include a summary savings window 1110, and a products view window 1130, in one example.

The savings window 1110 can display an amount of money saved using the system as a price comparison tool. In one example, savings can be calculated using multiple methods, and inform a user with a visual aid of how much they are saving. A purveyor savings summary 1112 can display purveyors that require a minimum amount of product to be ordered, and the saving window 1110 can include an indication of whether a user has met an order minimum in their current order by placing some type of graphic near the purveyor name. In one example, a purveyor's name may only populate the purveyor summary 1112 if a product/item count for that purveyor has a quantity greater that zero for a current order.

In another example, the savings window 1110 can include a visual aid allowing a user to see how much they have spent using the system during a current billing cycle. In one example, if a certain order threshold has been exceeded (e.g., $1500), a promotional bonus may be granted (e.g., a free month of service use, discounted fee, etc.).

The savings window 1110 can also include a search filters 1114 for further narrowing down search results in the products view window 1130, by cost, purveyor, and/or category. As shown, the product view window 1130 also includes a search bar 1133 that allows a user to search for word-specific products/items potentially using one of a plurality of standard matching algorithms. This functionality can search an entire catalog of all or select ASP sources for all or select purveyors. In one example, a user may add a desired product/item that isn't currently on product view window 1130 if they desire. That product/item can remain for future orders.

The product view window can include a view option bar 1132 with options to select full list, current order, or full catalog views. The entire list view can include all products/items across all added purveyors, and can be automatically generated using algorithm that fetches this information from predetermined lists included user-specific purveyor accounts. A current order view may only show products/items with quantity of greater than zero (a consolidated summary of products/items that are currently being ordered) for a current order.

The product view window and include a table with a title bar 1134 includes product information fields which may be populated from each row of the table below. These fields can include: purveyor name or logo; product or item name; brand of the product/item; pack size (this may be category title that is industry specific and represents an industry standard metric for an amount of products/items); size (this may be an industry standard metric that generally states a size of a container a product or item elements comes in); price of the product/items (for a last sync with an ASP source for the purveyor listed in the purveyor column for that row); and Total (=Price×Quantity (of pack)). In addition, the title bar also includes a price comparison column header 1136. For each row (line item) of the table, price comparison tag 1138 may be included. In one example, the price comparison tag 1138 can be a graphic that indicates if a cheaper comparable product/item is available. In one example, the tag may be displayed with different patterns or colors. For example, a red or blank patterned tag may indicate a savings is to be had relative to product in that row, whereas a green or patterned tag may indicate the product/item for that row is the cheapest of from that purveyor or relative to the comparable products/items.

A checkout button 1135 can be selected to finalize an order and go to shopping cart area. In one example, this may only become available to a user if a required quantity of at least one product/item it greater than zero (0), and a price minimum has been met.

A synchronization box 1140 can be displayed over the table in example of the present disclosure. The synchronization box 1140 can include selectable sync options 1142 including a favorites sync and a full sync.

In one example, the favorites sync can sync ASP sources for purveyors from a list that is predetermined, and only include ASP sources for purveyors that a user added, or ASP sources from which a select group of products specified by the user can be purchased. From previously added purveyors. In one example, these may products/items a user may order most frequently and/or require less time to obtain product information regarding than a full sync of all catalog products/items. In one example, all products/item information may be parsed through the orchestration service in a “locally” implemented process.

Regarding the full sync option, the system may retrieve an entire catalog of products from all ASP sources of all purveyors included for a user's system account. All product/item information may be parsed in same “locally” implemented process by the orchestration service, in one example. In one example, all synchronization functionalities may be active once a sync option is selected and carried out even if a browser has been closed. In this example, a final parsing may take place the next time a user logs into the system.

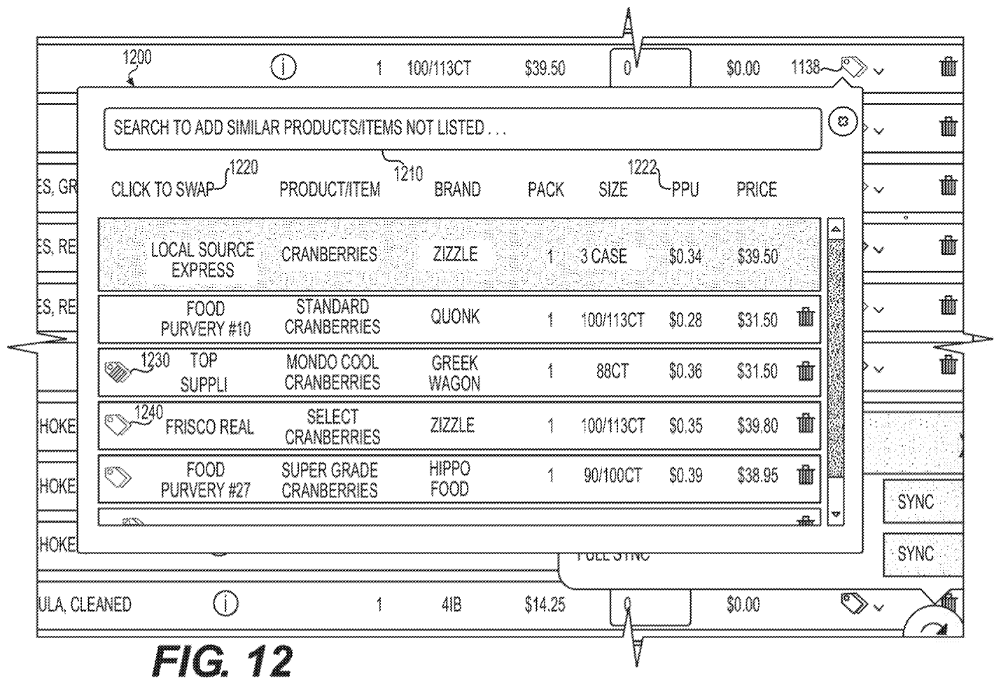

FIG. 12 is an illustration of an example graphical user interface 1200 (“GUI 1200”) of a console used to perform the various methods described herein. In one example, where on of price tag options 1138 is selected by user, a secondary window 1200 may be generated and display all comparable products/items to the product corresponding to the selected price tag option 1138. The techniques for determining comparable products/items can include text matching in combination with certain price, pack, size parameters. If the price tag 1138 is red or blank, that a potential less expensive alternative product/item may be available to that user, and the user may select a swap option 1220 to have the other product displayed. Where the price tag 1138 was green or patterned, then a potentially less expensive alternative was not found as a result of the price tag 1138 being selected (and the comparison window 1200 being displayed).

A top row of the comparison window 1200 can include a source product/item corresponding to the selected price tag 1138. This can allow a user to compare the original line product/item element with the comparable products in a stacked fashion as shown.

As shown, the comparison window 1200 includes a patterned tag 1230, and a blank tag 1240. The patterned tag 1230 indicates that the system has determined that a corresponding product is the most inexpensive comparable product/item calculated with respect to a price per unit 1222 (“PPU 1222”) field. In one example, the price per unit may be calculated as a total price divided by a pack multiplied by size. On the other hand, the blank tag 1240 indicates that a corresponding product is not the most inexpensive products/items as determined by a PPU calculation. The calculation for the PPU 1222 for each line item allows a user to break down the products/items into a smaller per unit size, in case pack and size columns differ and the user does not have to rely on a calculator to determine the most inexpensive product/item per unit size.

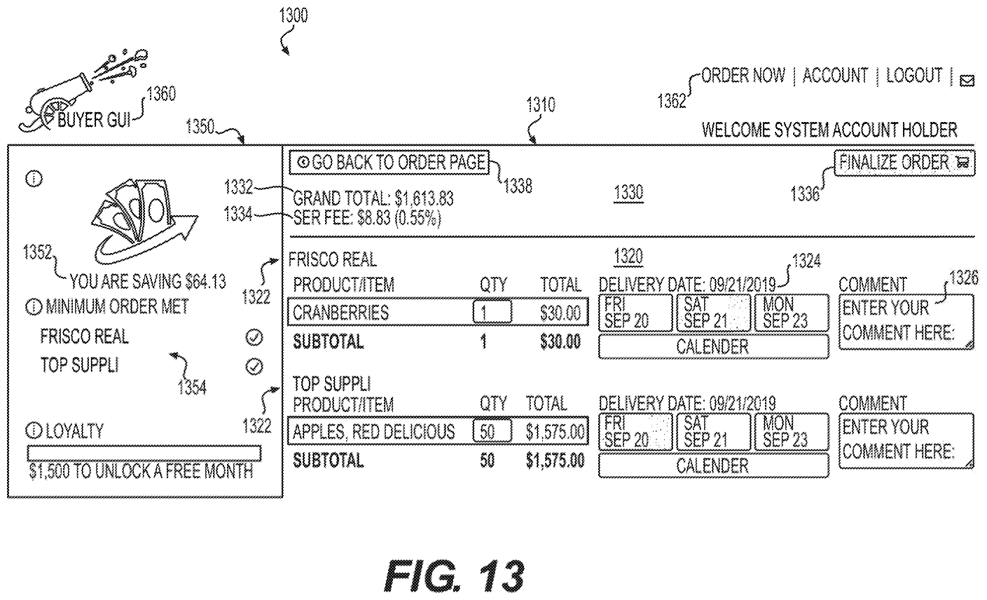

FIG. 13 is an illustration of an example graphical user interface 1300 (“GUI 1300”) of a console used to perform the various methods described herein. The selectable options 1338, 1360, 1362 can be selected to takes a user back to order page in case they wish to add additional products/items that are not currently in current order. A cost savings window 1350 can include saving summary for an entire order as a visual aid for a user upon checkout. This window can include a confirmation of price minimums met summary 1354 for each purveyor. All of the purveyors listed in this section may have to have to have a minimum requirement met for an entire order to be finalized.

A order summary bar 1310 can include a sale and fee summary section that include total 1332 for the order, and a service fee 1334 for an estimated fee associated with the use of the system for the order purchase (a predetermined usage fee based on percentage or other standard metric).

An order summary window 1320 can include a list of purveyor or product specific orders 1322. In one example, an order 1322 can be presented in a standard invoice format for which quantities can be adjusted. In a delivery date section 1324, a delivery dates available may be the same delivery dates available by for the user's account with corresponding ASP sources. A calendar feature is also added in case a user wishes to order a product/item outside of the next few delivery dates available. The order summary window 1320 may also include a comments box 1326 that allows a user to submit comments with their order that will also included with the user's order that is processed through an ASP source for the corresponding purveyor.

In order for the order to be submitted and processed by the corresponding ASP source, an order finalizing option 1336 must be selected. Selection of this option causes the system to compile all order data for each ASP source, and send is to each corresponding ASP source individually. Accordingly, a user can send a multiple purveyor order with a single selection of the order finalizing option 1336.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for retrieving and synthesizing product information from multiple purveyors and providing comparative purchasing options, the method comprising:
implementing an orchestration service on a computing device based on a first request to establish a connection with individual accounts associated with a system account;
proxying, with a server, a persistent connection from the orchestration service to connections established with a plurality of account-specific product information sources (“ASP sources”);
accessing accounts that are held with purveyors associated with the ASP sources and associated with the system account;
facilitating, with the server, transmission of account specific product information from the accounts to the orchestration service;
synchronize, with the orchestration service, purveyor-specific product information of the system account with the account specific product information;
synthesizing the purveyor-specific product information into inventory and price information for products corresponding to a product specified in a second request.

2. The system of claim 1, wherein said processing mechanism further comprises a daemon for processing information to or from any one of the plurality of ASP sources automatically.

3. The system of claim 1, wherein said web client connects to a hardware security module via a network, for ensuring safekeeping of user credentials.

4. The system of claim 1, wherein said user interface comprises a digital advertisement.

5. A system for allowing commercial buyers to aggregate product information and compare products from a plurality of ASP sources for multiple purveyors of a specific industry, the system comprising:
a memory storage including a non-transitory, computer-readable medium comprising instructions; and
at least one server including a processor configured to access the memory storage and execute the instructions to carry out stages comprising:
receiving access requests from client devices over a network;
identifying, for each access request, one or more purveyor-specific user accounts (“user accounts”) associated with the access request, each of the one or more user accounts requiring respective credentials for access to product information provided through the user account to be granted; and
generating responses to the access requests, each response configured to:
cause a client device to open a socket connection with each of the one or more user accounts,
obtain user-specific access to each of the one or more user accounts, and
provide respective product information from each of the one or more user accounts to a user interface (“UI”) on the client device.

6. The system of claim 5, wherein each response is configured to do one of provide, maintain, and modify the UI on the client device.

7. The system of claim 5,
wherein each response includes a package of server-side-generated code; and
wherein for each access request, the server communicates a corresponding response to a client device of the request and server-side-generated code of the corresponding response causes a browser on the client device to open socket connections with the purveyor-specific accounts for the access request.

8. The system of claim 7, wherein the server-side-generated code is configured to parse information from the user-accounts and cause one of the UI and the browser to display product information from the user accounts.

9. The system of claim 8, wherein the server-side-generated code causes the UI to be implemented within the browser.

10. The system of claim 5, the stages further comprising:
identifying, with the server, at least one second client device;
generating at least one second response to at least one access request, the second response configured to:
cause the client device to connect to the at least one second response, and
cause the at least one second client device to provide the client device with product information that is comparable to product information provided by at least one of the user accounts.

11. A system for allowing commercial buyers to aggregate product information and compare products from one or more of a plurality of purveyors, the system comprising:
a memory storage including a non-transitory, computer-readable medium comprising instructions; and
at least one server including a processor configured to access the memory storage and execute the instructions to carry out stages comprising:
enrolling client devices in an access service;
causing each enrolled client device to maintain user account information packages;
receiving access requests from the enrolled client devices over a network;
performing the stages for each access request including:
obtaining, from an enrolled client device corresponding to the access request, user account information packages for each user account associated with the access request,
implementing the user account information packages on each of the user accounts associated the access request to provide respective connections with the user accounts, and
maintaining the connections; and
facilitating a conveyance of product information from the user accounts to the client device through the connections.

12. The system of claim 11, the stages further comprising:
identifying, with the server, a first enrolled client device and a second enrolled client device; and
generating at least one second response to at least one access request from the first enrolled client device, the second response configured to:
cause the first enrolled client device to connect to the second client enrolled device, and
cause the second enrolled client device to provide the first client device with product information that is comparable to product information provided by at least one of the user accounts.
